(19) United States
(12) Patent Application Publication
(10) Pub. No.: US 2019/0017735 A1
(43) Pub. Date: Jan. 17, 2019

(54) HOUSEHOLD COOLING APPLIANCE COMPRISING A SPEECH CONTROL FOR A DISPENSER UNIT, WHICH IS CONFIGURED FOR DISPENSING LIQUID AND/OR ICE, AS WELL AS METHOD FOR OPERATING A HOUSEHOLD COOLING APPLIANCE

(71) Applicant: BSH HAUSGERAETE GMBH, Muenchen (DE)

(72) Inventor: HANS GERD KELLER, GIENGEN (DE)

(21) Appl. No.: 15/646,336

(22) Filed: Jul. 11, 2017

(51) Int. Cl. F25C 5/00; F25D 23/12; F25D 29/00; G06F 3/16

(52) U.S. Cl. CPC F25C 5/005; F25D 23/126; F25D 11/00; G06F 3/16; F25D 2400/361; F25D 29/00

(57) ABSTRACT

A household cooling appliance has a dispenser unit for dispensing liquid and/or ice. The dispenser unit is an actuation element for starting the dispensing of liquid and/or ice. A communication unit is configured for input and recognition of speech signals. A control unit is configured for performing at least one operating function of the dispenser unit depending on the recognized speech signal, and a starting signal for starting a speech signal input mode of the communication unit. There is also described a method for operating a household cooling appliance.

### TECHNICAL FIELD

The invention relates to a household cooling appliance comprising a dispenser unit for dispensing liquid and/or ice. Moreover the invention also relates to a method for operating such a household cooling appliance.

### BACKGROUND OF THE INVENTION

From the U.S. Pat. No. 6,882,280 B2 a household cooling appliance is known. This comprises a dispenser unit for dispensing liquid and/or ice. By way of manual actuation of buttons a user can select whether ice cubes, crushed ice, or liquid is to be dispensed. Moreover, this household cooling appliance also comprises a message unit, which is configured for recording and playing back speech information. A user can record speech information as messages, for instance information for other users or recipes or the like. These can then be retrieved when required and be output as speech information. This message unit can also comprises a display unit, on which information is optically displayed.

The operation of this household cooling appliance is relatively expensive and the operation complexity high. Which operations a user must perform in order to be able to select or perform specific functionalities, is hard to understand.

### SUMMARY OF THE INVENTION

It is the task of the present invention to provide a household cooling appliance as well as a method for operating such household cooling appliance, in which the operation is simplified, in particular the operation of the dispenser unit improved.

This task is solved by a household cooling appliance and a method according to the independent claims.

One aspect of the invention relates to a household cooling appliance. The household cooling appliance comprises a dispenser unit, which is configured for dispensing liquid and/or ice. The dispenser unit comprises an actuation element for starting the dispensing of liquid and/or ice. The household cooling appliance comprises a communication unit, which is configured for input and recognition of speech signals. The household cooling appliance comprises a control unit, which is configured for performing at least one operating function of the dispenser unit depending on the recognized speech signal.

The household cooling appliance preferably also comprises a starting element for starting a speech signal input mode of the communication unit.

A further aspect of the invention relates to a method for operating a household cooling appliance, comprising the following steps:

In particular starting a speech signal input mode of a communication unit of the household cooling appliance with a starting element of the household cooling appliance;
generating a speech signal and capturing the speech signal by the communication unit;
performing an operating function of a dispenser unit of the household cooling appliance through a control unit depending on a recognized speech signal, wherein the dispenser unit is configured for dispensing liquid and/or ice.

Further features of the invention derive from the claims, the figures, and the description of the figures. The features and feature combinations previously named in the description as well as the features and feature combinations named in the following in the description of the figures and/or in the figures alone are usable not only in the respective indicated combination but also in other combinations, without leaving the scope of the invention. Thus, also embodiments of the invention are to be considered as being comprised and disclosed, which are not explicitly shown and explained in the figures, however derive through separated feature combinations from the explained embodiments and can be generated therefrom. Also explanations and feature combinations are to be regarded as disclosed, which thus do not comprise all features of the originally formulated independent claim. Moreover, embodiments and feature combinations, in particular by the above set out embodiments are to be considered as being disclosed, which go beyond the feature combinations set out in the back-references of the claims or deviate therefrom.

### BRIEF DESCRIPTION OF THE DRAWINGS

Embodiments of the invention are explained in the following in more detail on the basis of schematic drawings. These show in:

FIG. 1 a perspective view of an embodiment of a household cooling appliance according to the invention; and

FIG. 2 a further representation of the household cooling appliance according to FIG. 1

### DETAILED DESCRIPTION OF PREFERRED EMBODIMENTS

In the figures identical and functionally identical elements are equipped with the same reference signs.

With indications “top”, “bottom”, “front”, “back”, “horizontal”, “vertical”, “depth direction”, “width direction”, “height direction” etc. the positions and orientations given in the case of intended use and intended arrangement of the ice maker bowl or the device are indicated.

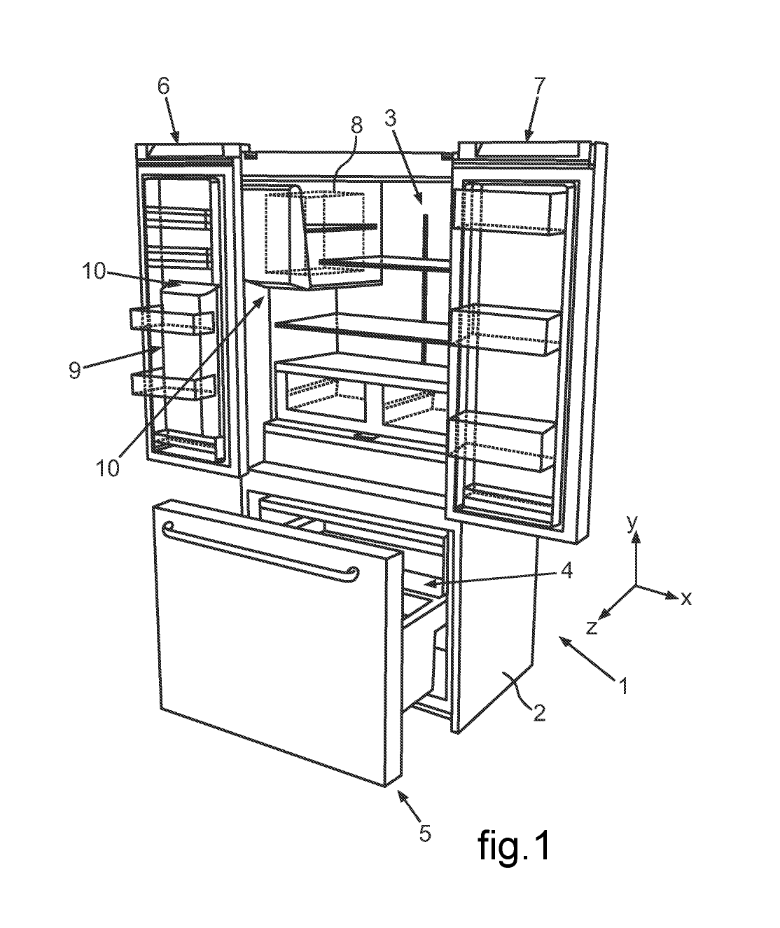

In FIG. 1 in a perspective view an embodiment of a household cooling appliance 1 is shown. The household cooling appliance 1 is configured for storing and preserving food. In the shown embodiment the household cooling appliance 1 is a fridge-freezer combination. However, it can equally as well be only a cooling appliance.

The shown household cooling appliance 1 comprises an outer housing 2. In the outer housing 2 a first receiving space for food is formed, which here is a cooling compartment 3. The household cooling appliance 1 moreover comprises a second receiving space for food that is separate from the first receiving space and here is a freezer compartment 4. As can be seen, in the embodiment shown here the cooling compartment 3 and the freezer compartment 4 are arranged one above the other in the height direction (y direction) of the household cooling appliance 1. The freezer compartment 4, which is arranged further down, is capable of being closed by a door 5. The door 5 in the shown embodiment is a front wall of a drawer, which can be linearly slid in the depth direction (z direction) of the household cooling appliance 1. The cooling compartment 3 is capable of being closed on the front side by two separate doors 6 and 7, which in FIG. 1 are shown in the opened state. The two separate doors 6 and 7 are capable of being pivoted about pivot axes, which are vertically orientated, and are arranged on the outer housing 2. The two doors 6 and 7 are arranged in the width direction (x direction) next to each other and extend in the closed state in a front side plane. In particular the door 5 in the closed state also extends in this plane, in which also the two doors 6 and 7 extend in the closed state.

The number of doors and their arrangement and position on the outer housing could be different to the embodiment above, too. Therefore an embodiment can comprise only two front doors which are arranged in the width direction (x direction) next to each other and extend in the closed state in a front side plane. A further embodiment comprise only one front door.

The household cooling appliance 1 moreover comprises a dispenser unit 10, which is configured for dispensing ice form elements or crushed ice. The dispenser unit 10 moreover can also optionally be configured for dispensing a beverage. The dispenser unit 10 comprises an ice maker unit 8. The ice maker unit 8 in the shown embodiment is arranged internally in the cooling compartment 3. This means, whilst the ice maker unit 8 is configured and arranged to be thermally insulated against the cooling compartment 3, however, it is accessible and reachable only via the feeding aperture of the cooling compartment 3. Thus, the ice maker unit 8 can only be made accessible, if at least the door 6 is opened.

The dispenser unit 10 in addition to the ice maker unit 8 also comprises an output unit 9. The output unit 9 here for instance is integrally formed in the door 6. At an outer side of the door 6 facing away from the cooling compartment 3, which then is also a front side, a niche is formed, into which a collection container can be put and into which then via the output unit 9 the ice form elements or the crushed ice can be dispensed.

The dispenser unit 10 is configured for making and dispensing ice, such as ice cubes or crushed ice. The dispenser unit 10 is also configured for dispensing liquid. Here beverages can be produced and dispensed, which can also be mixed drinks. Equally as well beverages can be fizzy or still. For the production of fizzy drinks the household cooling appliance 1 can for instance comprise a cartridge with carbonic acid, which can be added to the liquid.

For producing mixed drinks the dispenser unit 10 can comprise at least two different containers, in which two different liquids can be contained, which then can be added to a mixed drink.

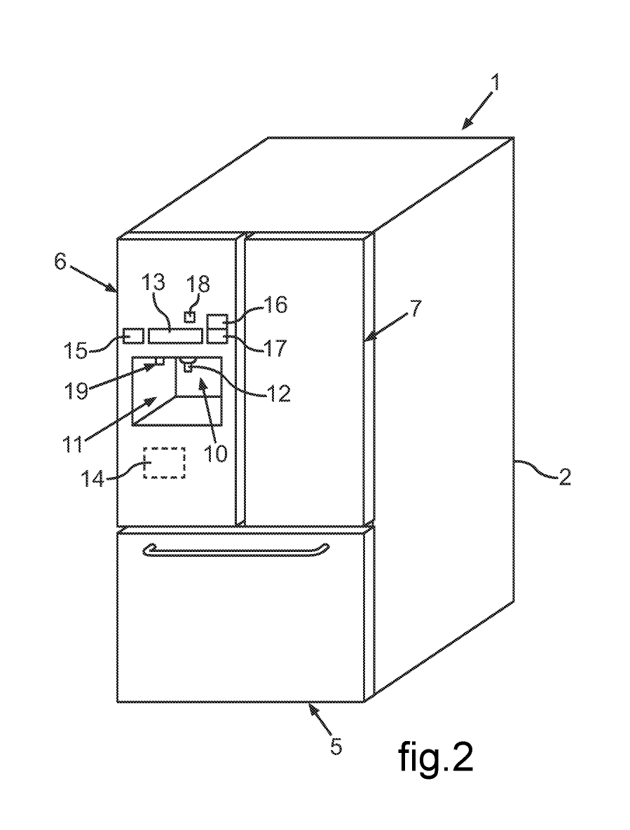

In FIG. 2 the household cooling appliance 1 is shown with closed doors 6 and 7. In the shown embodiment it can be seen that for instance on the door 6 a niche 11 is formed, which is accessible from the front. Into the niche 11 a drinking vessel can be put, in order to then be able to insert the liquid to be dispensed and/or the ice to be dispensed into the drinking vessel. The dispenser unit 10 for this purpose comprises an actuation element 12. This actuation element 12 is arranged in the niche 11 and freely accessible. In the embodiment the actuation element 12 is a pivotable lever. This actuation element 12 thus can in particular be pivoted about a horizontal axis and thus be pushed backwards by force effect through a user. Thereby the dispensing operation is started.

In the shown embodiment the household cooling appliance 1 comprises a communication unit 13. The communication unit 13 is configured for input and recognition of speech signals. It can for instance, as shown in FIG. 2, be arranged on the door 6. However, it can also be arranged for instance on the door 7 or in a different position on the household cooling appliance 1. The household cooling appliance 1 moreover also comprises a control unit 14. The control unit 14 is configured for performing at least one operating function of the dispenser unit 10. This is effected in particular in dependence on the recognized speech signal, which can be input by a user via the communication unit 13. The speech signal can be a signal directly spoken by the user. The speech signal, however, can for instance also be recorded on a portable recording device and then be correspondingly played and then be recognized by the communication unit 13. For instance such a signal can be played by a portable communication end device, such as a smart phone or the like, which is a recording device, and thus an acoustic signal be generated, which is recognized by the communication unit 13. Thus, an indirect input of a speech signal can be effected by a user into the communication unit 13.

Generally it is thus facilitated to operate a concrete functional unit of the household cooling appliance 1, namely the dispenser unit 10, by speech control and to select and/or perform specific operating functions of this concrete functional unit through speech signals. By such a design thus a simpler and more intuitive operation of this concrete functional unit of the household cooling appliance 1 is facilitated. A user no longer must explicitly perform a manual actuation of actuation buttons in this connection, in order to be able to select and/or start corresponding operating functions of this concrete dispenser unit 10. Rather, by his speech signals he can select and/or start the operating functions and in this connection then also has his hands free for performing other activities. For instance in this connection it is then also already possible that he obtains a drinking vessel but still, possibly also at a certain distance from the household cooling appliance 1, already enters a speech command in order to be able to produce a certain liquid and/or ice. Thus a user can start immediately with the dispensing operation when he has obtained the drinking vessel and approaches the household cooling appliance 1, in particular places the drinking vessel into the niche 11. This is the case since possibly the preparation time for making the ice and/or the desired liquid, for instance a mixed drink, comes within the period of time in this sense already, in which the user possibly only obtains the drinking vessel or possibly only washes it. Moreover, by such a speech control of this dispenser unit 10 it is also facilitated that during an output operation a further speech communication can take place with the household cooling appliance 1 and both hands are still free, for instance for filling two drinking vessels immediately one after the other, which are held in the two hands. Equally, it is then also facilitated that during the dispensing operation of liquid and/or ice also yet another activity, for instance the opening of the door 7, can take place and still an output operation can then be terminated by entering a speech signal. By the speech control of the dispenser unit 10 a simultaneous multifunctional operating of the household cooling appliance 1 can be effected by a user. This is the case as he then with his hands can simultaneously perform other adjustments and operations as well as handling activities for instance on the household cooling appliance 1.

In an advantageous embodiment it is envisaged that the communication unit 13 is configured not only for speech input, but also for speech output. This means that the communication unit 13 itself can output speech information. This is then advantageous if a speech dialogue with the user is meant to take place. For instance this may then be the case if a speech input is confirmed by a user through a speech output signal of the communication unit 13. Thereby the safety of the speech control can be increased since the user then also learns whether the household cooling appliance 1 correctly understood his speech input. Moreover, it may then also be facilitated that by such a speech output a checking-back of the communication unit 13 can occur, if a speech input was not or only insufficiently understood by a user. Equally as well it is possible that in the speech output by the communication unit 13 the communication is generally only started in that the communication unit 13 asks the user for input of a speech signal. By such a first step of the communication unit 13 the user also knows that the device now is in a corresponding mode for recognizing speech signals.

Moreover, by such a speech output through the communication unit 13 an information can be provided to the user, which represents the specific states during a process. For instance also the end of a preparation process of ice and/or the information about the end of a liquid to be dispensed, for instance a mixed drink, can be output as speech signal. The user is then informed by a speech signal when he can then start the actual output of a medium desired and requested by him.

In an advantageous embodiment the household cooling appliance 1 also comprises a gesture recognition module 15. Thus, the recognition of touch-free executed gestures can be facilitated. As gestures thus in particular only such gestures are understood that are executed without touching an operating element, for instance a touch-sensitive operating element. In the sense of a gesture thus here in particular such is not understood, which is performed by putting a finger on a touch-sensitive operating element and a swiping across this operating element is performed in the state in which the finger is put thereon. A swiping gesture thus is not to be taken as touch-free performed gesture. By the communicating by means of gestures then, if the household cooling appliance 1 does not recognize the speech input signal, a corresponding operation can be performed. Even if the household cooling appliance 1 is positioned in an environment, in which periodically or permanently possibly interfering environmental noise may occur, this is then correspondingly advantageous. By such, in particular then also multifunctional multivariable input option, on the one hand by speech input, on the other hand by a gesture, the household cooling appliance in the most varied situations can still be used safely and reliably.

Moreover, it may be envisaged that the household cooling appliance 1 comprises an input unit 16, which comprises at least one manually operable operating element. Also thereby individual settings can be made. Preferably it is envisaged that the household cooling appliance 1 is configured without such input unit 16. In such an embodiment then it is preferably envisaged that the entire operation of the household cooling appliance 1 is effected through speech signals and/or touch-free gestures.

It may also be envisaged that the input unit 16 with the at least one manual operating element is only configured for performing the general turning-on and turning-off of the household cooling appliance 1. All further settings can then be effected by speech signals and/or gestures. It may also be envisaged that via the input unit 16 and the present manual operating element only an emergency-off-function is connected.

In a further advantageous embodiment it is envisaged that the household cooling appliance 1 comprises an optical display unit 17. Thereon information about operating states can be displayed. In this connection then also selected operating functions through text and/or symbols can be displayed. Equally, values of operating parameters of the household cooling appliance 1 can be displayed. Equally it is possible that on the display unit 17 speech commands are displayed, with which operating functions, in particular of the dispenser unit 10, can be selected and started. This is then very advantageous if a user no longer remembers speech commands or no longer remembers them exactly so that via the display unit 17 practically the dictionary of these stored speech commands can be retrieved.

Moreover it is also possible that via the display unit 17 a priority list of speech commands is displayed. Thus here for example a user-individual priority list can be drawn up. To an individual user then this list can be displayed so that he also can very quickly recognize on the display unit 17 which are the operating functions preferred by him with the associated speech signals or speech commands. A very fast and faultless speech control is thereby rendered possible. Equally, it is possible that the household cooling appliance 1 itself prepares this priority list on the basis of the user behavior in the past and same then is displayed automatically or upon request of a user.

In a further advantageous embodiment it may be envisaged that the communication unit 13 is configured for user-individual creating of speech signals. Thereby a user quasi can draw up his own individual dictionary of speech signals. Thereby the intuitive and user-friendly speech control of the household cooling appliance 1 is improved once again. Possibly difficult words or sentences that are counterintuitive to the user can thereby be avoided and every user can then define his own dictionary with speech signals.

In an advantageous embodiment the household cooling appliance 1 comprises a user identification unit 18. This can for instance be a camera or a biometric sensor. Thereby a user identification can be effected safely and reliably.

In an advantageous embodiment it is envisaged that the household cooling appliance 1 comprises a starting element for starting a speech signal input mode of the communication unit 13. This can be an element that is separate from the actuation element 12. In an advantageous embodiment it is envisaged that the actuation element 12 at the same time is also this starting element. Thereby a particularly fast and safe operation can be effected and the number of operating steps to be performed in the most varied ways is reduced.

With regard to an operating function of the dispenser unit 10, which is performed independently of the recognized speech signal, this can be a liquid dispensing function. A liquid dispensing function can here be the kind of liquid and/or the quantity of liquid and/or the time of dispensing the liquid. Moreover, as liquid dispensing function with regard to the kind of liquid its composition can be determined. Thus, in this connection for instance also a mixed drink with at least two different liquids or a mixed drink with one liquid and one added component, such as for instance a powder or a gel, can be specified. Also as a liquid dispensing function such a function is to be understood, which selects a cooled beverage or a hot drink. Also the addition of carbon dioxide to a liquid is to be understood as liquid dispensing function.

Moreover, an operating function of the dispenser unit 10 can also be an ice dispensing function. Also in the case of an ice dispensing function then the kind of the ice, for instance ice cubes or crushed ice, and/or the quantity can be specified and be stored or connected as speech signal.

Equally it is possible that an operating function is a specific operating state of an illumination of the dispenser unit 10. For instance here the turning-off of an illumination or the turning-on or the dimming of an illumination can be envisaged. Also the changing of a colour of light of this illumination can be a corresponding operating function.

In a further advantageous embodiment it is envisaged that the communication unit 13 for communication is designed in at least two different languages. Thereby a user can select one individual communication language. For this purpose the communication unit 13 comprises a language selection module for selecting an individual communication language.

In an advantageous embodiment the operation of the household cooling appliance 1 is effected in that with regard to a desired dispensing of a medium, for instance liquid and/or ice, a user to start with actuates the actuation element 12 in an advantageous way, in particular pivots it out of a basic position. By this approach to start with, however, no dispensing of liquid and/or ice is started yet, since an operating function of the dispenser unit 10 has not yet been selected or performed prior thereto. In this connection thus the control unit 14 recognizes that by this actuation of the actuation element 12 currently only the speech signal input mode of the communication unit 13 is started. In particular for the further input of speech signals it is then envisaged that this actuation element 12 stays permanently actuated, i.e. is kept pivoted out of its pivoted basic position. It may also be envisaged that after this first actuation of the actuation element 12 same is returned into the basic position and also by this first actuation mode then the speech input mode of the communication unit 13 is started.

After this operating step it is preferably envisaged that the communication unit 13 starts a speech dialogue by outputting a speech signal and asking the user for input, in particular for inputting the desired operating function of the dispenser unit via a speech signal. In a further step following then the user then enters this wish and generates a speech signal, which is assigned to the desired operating function of the dispenser unit 10. If this speech input is recognized by the communication unit 13, possibly confirmed by the repeated checking-back, then the output of the medium, which was requested by the desired operating function, is effected, if the operating function is a liquid dispensing function or an ice dispensing function. This is then effected automatically and immediately, if the actuation element 12 after the above-named first actuation had stayed further pressed down. If this has not been the case in the named alternative embodiment, it then is required at the time that the user pivots the actuation element 12 a second time out of the basic position in order to then start the actual dispensing of the liquid and/or the ice.

If the actuation element 12 then again is moved back from the pivoted position into the basic position, this dispensing of the liquid and/or the ice is stopped. Also an automatic stopping of this input may happen if the possibly entered desired quantity has been reached and output.

By the named household cooling appliance 1 same is variably and multifunctionally operated. In the very case if it is only or predominantly controlled by speech signals, also an input unit 16 is not required or only one of very small design. Thereby the household cooling appliance can also be configured to be very space-saving particularly with regard to an undesired complex input unit 16. Since in this case no predefined visible manual operating elements are present either, in a very simple way also the manufacturing of different accessories of the household cooling appliance 1 or of different variations of the household cooling appliance 1 can be realized. This is the case since specific operating functions can be simply supplemented or blocked via a speech command, however, on the front side equipment of the household cooling appliance 1 this does not change anything. This is because in this connection then no additional manual operating element must be added or removed.

The household cooling appliance 1, in particular the dispenser unit 10, comprises an illumination 19. Operating functions of the illumination 19 can be selected and/or started by speech signals.

Very generally one aspect of the invention relates to the embodiment that the actuation element is the starting element. The actuation element can be a pivotable lever. It may also be envisaged that the starting element is a gesture recognition module. One operating function of the dispenser unit can be a liquid dispensing function. One operating function of the dispenser unit can also be an ice dispensing function. One operating function according to a further aspect can be a turn-on function or a turn-off function of an illumination of the dispenser unit. A further aspect of the invention relates to a speech selection module of the household cooling appliance, which is configured for selecting an individual communication language. According to a further aspect of the invention the communication unit is configured for user-individual programming of an assignment of the speech command to an operating function. A further aspect of the invention envisages that the operating functions of the household cooling appliance, in particular the dispenser unit, can be selected only through speech signals. In a further aspect it is envisaged that the communication unit is also configured for outputting speech signals. The household cooling appliance according to a further aspect can comprise an optical display unit.

In this aspect the method for operating a household cooling appliance it can be envisaged that by an actuation of an actuation element of the dispenser unit the dispensing of liquid or ice is started. According to a further aspect in a speech signal input mode by a speech signal a user can be asked to input a speech signal. A further aspect of the method envisages that a starting element of the household cooling appliance, by which a speech signal input mode is started, is formed by an actuation element of the dispenser unit, wherein this actuation element is configured for manual actuation and is envisaged for starting upon actuation the dispensing of liquid and/or ice.

Upon actuation of the actuation element for starting the speech signal input mode and a recognition of the speech signal upon a further actuation of this actuation element the performing of the liquid dispenser or the ice dispenser as an operating function the dispenser unit is controlled by the control unit. In a further aspect of the method it is envisaged that the actuation element in the period of time between starting the speech signal input mode and the dispensing of liquid or ice is permanently actuated and thus in particular was pivoted from its basic position into a pivot position and in this regard held there.

### LIST OF REFERENCES

1 household cooling appliance
2 outer housing
3 cooling compartment
4 freezer compartment
5 door
6 door
7 door
8 ice maker unit
9 output unit
10 dispenser unit
11 niche
12 actuation element
13 communication unit
14 control unit
15 gesture recognition unit
16 input unit
17 display unit
18 user recognition unit
19 illumination

1. A household cooling appliance comprising:
a dispenser unit for dispensing liquid and/or ice, wherein the dispenser unit comprises an actuation element for starting the dispensing of liquid and/or ice,
a communication unit which is configured for input and recognition of speech signals,
a control unit, which is configured for performing at least one operating function of the dispenser unit depending on the recognized speech signal, and
a starting element for starting a speech signal input mode of the communication unit.

2. The household cooling appliance according to claim 1, wherein the actuation element is the starting element.

3. The household cooling appliance according to claim 1, wherein the actuation element is a pivotable lever.

4. The household cooling appliance according to claim 1, wherein the starting element is a gesture recognition module.

5. The household cooling appliance according to claim 1, wherein an operating function is a liquid dispensing function.

6. The household cooling appliance according to claim 1, wherein an operating function is an ice dispensing function.

7. The household cooling appliance according to claim 1, wherein the dispenser unit comprises an illumination, and an operating function is a turn-on function or a turn-off function of the illumination.

8. The household cooling appliance according to claim 1, wherein communication unit comprises a language selection module for selecting an individual communication language.

9. The household cooling appliance according to claim 1, wherein the communication unit is configured for user individual programming of an assignment of a speech command to an operating function.

10. The household cooling appliance according to claim 1, wherein the operating functions of the household cooling appliance can only be selected by speech signals.

11. The household cooling appliance according to claim 1, wherein the household cooling appliance comprises an input unit with at least one operating element, wherein by the actuation of the operating element an operating function of the household cooling appliance without speech signal can be selected.

12. The household cooling appliance according to claim 1, wherein the communication unit is configured for outputting speech signals.

13. The household cooling appliance according to claim 1, wherein the household cooling appliance comprises a display unit.

14. A method for operating a household cooling appliance, the method comprising the following steps:
starting a speech signal input mode of a communication unit of the household cooling appliance comprising a starting element of the household cooling appliance,
generating a speech signal,
capturing the speech signal by the communication unit (13), and
performing an operating function of a dispenser unit of the household cooling appliance through a control unit depending on an recognized speech signal, wherein the dispenser unit is configured for dispensing liquid and/or ice.

15. The method according to claim 14, wherein by an actuation of an actuation element of the dispenser unit the dispensing of liquid or ice is started.

16. The method according to claim 15, wherein in the speech signal input mode an input of a speech signal is asked by a speech signal outputted by the communication unit.

17. The method according to claim 14, wherein the starting element is formed by an actuation element of the dispenser unit, and upon actuation of the actuation element for starting the speech signal input mode and a recognition of the speech signal, upon a further actuation of the actuation element the performing of the liquid dispense or the ice dispense is controlled as an operating function through the control unit.

18. The method according to claim 17, wherein the actuation element between the starting of the speech signal input mode and the dispensing of the liquid or ice is permanently actuated.

19. The method according to claim 14, wherein as an operating function a turn-on function or a turn-off function of an illumination of the dispenser unit is performed.
